(19) United States
(12) Patent Application Publication
(10) Pub. No.: US 2020/0145389 A1
(43) Pub. Date: May 7, 2020

(54) Controlling Access to Data

(71) Applicant: Scentrics Information Security Technologies Ltd, South Nutfield, Redhill Surrey (GB)

(72) Inventors: John Steward SHAWE-TAYLOR, London (GB); Guru Paran CHANDRASEKARAN, London (GB)

(21) Appl. No.: 16/625,232

(22) PCT Filed: Jun. 21, 2018
(86) PCT No.: PCT/GB2018/051735

§ 371 Date: Dec. 20, 2019

(30) Foreign Application Priority Data
Jun. 22, 2017 (GB) 1710013.2

(51) Int. Cl. H04L 29/06; G06F 21/60; H04L 9/14

(52) U.S. Cl. CPC H04L 63/0435; H04L 63/062; H04L 9/14; G06F 21/602; H04L 63/101

(57) ABSTRACT

A data encryption and decryption system is provided. An electronic encryption apparatus is configured to extract a feature set from plaintext data using a lossy algorithm, encrypt the feature set, send it to a feature server, receive an access control list (ACL), send this to a key server, and receive back an encryption key, which is used to encrypt the plaintext data. A data identifier is also exchanged. An electronic decryption apparatus is configured to send the data identifier to the key server, identify an entity to the key server, receive a decryption key from the key server, and decrypt the encrypted data. The key server stores the ACL and data identifier in mutual association. When it receives a data identifier and entity identifier from the electronic decryption apparatus, it checks the entity is on the ACL associated with the data identifier, and returns the decryption key.

This invention relates to devices, systems and methods for encrypting and decrypting data.

Mathematical encryption algorithms are widely used to protect data while it is in storage or in transit. Possession of a valid cryptographic decryption key allows the encrypted data to be decrypted and used. For example, the author of an email may encrypt a sensitive attachment before sending the email over the Internet to one or more recipients.

If a party possesses a valid decryption key, that party can access the original data (also referred to as the plaintext data). A party who does not possess a valid decryption key cannot access the original data.

The applicant has realised, however, that such binary access control (i.e., access or no access, depending on possession or not of a key) has certain limitations. In particular, the applicant has realised that there are situations in which it would be desirable to have finer-grained control over how sensitive data can be accessed and used.

The present invention therefore seeks to provide an architecture and mechanisms that enable a greater level of control over access to sensitive data.

From a first aspect, the invention provides an electronic encryption apparatus configured to:
receive an instruction to encrypt plaintext data;
receive an access control list (ACL) that identifies one or more entities that are to be permitted to decrypt the data;
send the access control list to a key server;
receive, from the key server, a cryptographic encryption key;
exchange, with the key server, a data identifier for the data;
apply a lossy feature extraction algorithm to the plaintext data, to extract a feature set;
encrypt the feature set to generate an encrypted feature set;
send the encrypted feature set to a feature server;
encrypt the plaintext data, using the received cryptographic encryption key, to generate encrypted data; and
store the encrypted data and the data identifier.

Thus it will be seen by those skilled in the art that, in accordance with the invention, access to the plaintext data can be restricted to a list of authorised entities (e.g., people, organisations, or machines), while one or more further entities may be granted partial access to the data by means of a lossy feature extraction algorithm. The feature set extracted by the algorithm does not contain the full information content of the plaintext data, but can still contain a reduced amount of information, so as to be useful for certain purposes, such as statistical analysis. The choice of feature extraction algorithm therefore represents a balance between privacy and the release of some limited information.

By way of example, the electronic encryption apparatus may be a laptop computer, and a user may be about to send a sensitive email or social-media post. Once the user has entered a list of recipients for the email or social-media post, the computer may send the list to the key server, which returns a cryptographic encryption key and an email identifier string. The computer may then apply an algorithm to the email or social-media message that generates an alphabetically-sorted list of every word that appears at least once in the email or message. It will not, in general, be possible to reconstruct the original email or message from such an alphabetical list; however, the list does nevertheless contain information about the email or message that may be useful. The laptop computer encrypts the alphabetical list and sends it, along with the email or message identifier string, to the feature server. The computer encrypts the email or message, using the received encryption key, and stores it temporarily in RAM, before sending it over the Internet to the intended recipients, or to a server of a social-media platform. The feature server may use the alphabetical word list for various purposes—for example, it may be used by an advertising company to select what advertisements to display to the user, based on particular key-words appearing in the user's emails or on a web page of the social-media platform, or to screen out unsuitable content.

Of course, these are just some possible embodiments. Many other types of feature extraction algorithm, and uses for the feature set, are possible, as will be described in more detail below.

Having an identifier for the data and an ACL that are known to the key server enables the key server to respond appropriately to any future request relating to the particular encrypted data. In particular, it allows the key server to be able to provide an appropriate decryption key to an authorised client device, relating to the encrypted data.

From a second aspect, the invention provides an electronic decryption apparatus configured to:
receive an instruction to decrypt encrypted data, the encrypted data having a data identifier;
send the data identifier to a key server;
identify an entity to the key server;
receive, from the key server, a cryptographic decryption key associated with the data identifier;
decrypt the encrypted data, using the cryptographic decryption key, to recover plaintext data; and
store the plaintext data.

From a third aspect, the invention provides a key server configured:
to receive an access control list from an electronic encryption apparatus;
to send a cryptographic encryption key to the electronic encryption apparatus;
to exchange a data identifier with the electronic encryption apparatus;
to store the data identifier and the access control list, in mutual association in a data store;
to receive, from an electronic decryption apparatus, an incoming data identifier;
to receive, from the electronic decryption apparatus, an identification of an entity;
to identify, in the data store, an access control list associated with the incoming data identifier;
to check whether the entity is on the access control list associated with the incoming data identifier; and
if the entity is on the access control list associated with the incoming data identifier, to retrieve or generate a cryptographic decryption key associated with the incoming data identifier, and to send the cryptographic decryption key associated with the incoming data identifier to the electronic decryption apparatus.

From a fourth aspect, the invention provides a data encryption system comprising an electronic encryption apparatus and a key server, wherein the electronic encryption apparatus is configured to:
receive an instruction to encrypt plaintext data;
receive an access control list (ACL) that identifies one or more entities that are to be permitted to decrypt the data;
send the access control list to the key server;
receive, from the key server, a cryptographic encryption key;
exchange, with the key server, a data identifier for the data;
apply a lossy feature extraction algorithm to the plaintext data, to extract a feature set;
encrypt the feature set to generate an encrypted feature set;
send the encrypted feature set to a feature server;
encrypt the plaintext data, using the received cryptographic encryption key, to generate encrypted data; and
store the encrypted data and the data identifier, and wherein the key server is configured:
to receive the access control list from the electronic encryption apparatus;
to send a cryptographic encryption key to the electronic encryption apparatus;
to exchange said data identifier with the electronic encryption apparatus; and
to store the data identifier and the access control list, in mutual association in a data store.

The key server in this data encryption system may be further configured:
to receive, from an electronic decryption apparatus, an incoming data identifier;
to receive, from the electronic decryption apparatus, an identification of an entity;
to identify, in the data store, an access control list associated with the incoming data identifier;
to check whether the entity is on the access control list associated with the incoming data identifier; and
if the entity is on the access control list associated with the incoming data identifier, to retrieve or generate a cryptographic decryption key associated with the incoming data identifier, and to send the cryptographic decryption key associated with the incoming data identifier to the electronic decryption apparatus.

In some embodiments the feature server may be a further component of the data encryption system.

From a further aspect, the invention provides a data encryption method, comprising an electronic encryption apparatus:
receiving an instruction to encrypt plaintext data;
receiving an access control list (ACL) that identifies one or more entities that are to be permitted to decrypt the data;
sending the access control list to a key server;
receiving, from the key server, a cryptographic encryption key;
exchanging, with the key server, a data identifier for the data;
applying a lossy feature extraction algorithm to the plaintext data, to extract a feature set;
encrypting the feature set to generate an encrypted feature set;
sending the encrypted feature set to a feature server;
using the received cryptographic encryption key to encrypt the plaintext data, to generate encrypted data; and
storing the encrypted data and the data identifier.

Some embodiments of this data encryption method further comprise the key server:
receiving the access control list from the electronic encryption apparatus;
sending the cryptographic encryption key to the electronic encryption apparatus;
exchanging said data identifier with the electronic encryption apparatus; and
storing the data identifier and the access control list, in mutual association in a data store.

From another aspect, the provides a data decryption method, comprising an electronic decryption apparatus:
receiving an instruction to decrypt encrypted data, the encrypted data having a data identifier;
sending the data identifier to a key server;
identifying an entity to the key server;
receiving, from the key server, a cryptographic decryption key associated with the data identifier;
using the cryptographic decryption key to decrypt the encrypted data, to recover plaintext data; and
storing the plaintext data.

Some embodiments of this data decryption method further comprise the key server: receiving the data identifier from the electronic decryption apparatus;
receiving an identification of said entity from the electronic decryption apparatus;
identifying, in a data store, an access control list associated with the data identifier;
checking whether the entity is on the access control list associated with the data identifier; and
if the entity is on the access control list associated with the data identifier, retrieving or generating the cryptographic decryption key associated with the data identifier, and sending the cryptographic decryption key associated with the data identifier to the electronic decryption apparatus.

The electronic encryption apparatus may comprise multiple distinct devices, but is preferably a single electronic encryption device. Similarly, the electronic decryption apparatus may comprise multiple distinct devices, but is preferably a single electronic encryption device. Each may be a portable device. Each may be a personal communication device, such as a cell phone or smartphone. Each may provide a user interface for receiving data from a user and/or for outputting data to a user. Each may be a tablet computer, a laptop computer, a personal computer, a server, a domestic appliance, or any other suitable device.

The encryption apparatus may comprise a non-volatile memory, such as a magnetic disk or flash member, and may store the encrypted data and/or the data identifier in the non-volatile memory. It may comprise volatile memory, such as RAM, and may store the encrypted data and/or the data identifier in the volatile memory. The storage may be long-term or only temporary. The encryption apparatus may be configured to process the encrypted data and/or the data identifier in any appropriate way. It may be configured to transmit the encrypted data over a communication channel or network. It may output the encrypted data to a wired or wireless link. It may send the encrypted data to one or more, or all, of the entities on the access control list—e.g., by outputting one or more messages addressed to one or more of the entities. It may send the data identifier to one or more, or all, of the entities on the access control list, optionally in a same message as the encrypted data, but possibly in a different message or even over a different channel.

One device, such as a mobile telephone, may be configured to be both an electronic encryption apparatus, as described herein, and an electronic decryption apparatus, as described herein. The device may be used to send and receive the same plaintext data, but, more typically, would be used to encrypt first plaintext data, to generate first ciphertext data, and to decrypt second ciphertext data to obtain second plaintext data, different from the first plaintext data.

The electronic encryption apparatus may be configured to receive an instruction from a human user to encrypt the plaintext data—e.g., at a user-interface of the apparatus such as a touchscreen or keyboard. The instruction may be explicit or implicit (e.g., implicit when commanding the sending of an email or other electronic message). The encryption apparatus may comprise an interface for receiving or generating the plaintext data, such as a keyboard, microphone or camera. It may comprise an interface for receiving the plaintext data over a wired or wireless data connection, such as a WiFi network or a memory-card slot. It may generate the plaintext data internally, e.g., by processing data received from one or more of these interfaces.

The plaintext data may take any form and may represent anything. It is preferably binary data. It may comprise any one or more of: text data, image data, audio data, and executable code. In one set of embodiments it is a post on a social-media platform. Although it is described, for convenience, as “plaintext” data, this does not mean the data is necessarily in a form that is intelligible to a user of the encryption apparatus; the data could, for example, be compressed—e.g., in a zip file—and be decompressed as part of the feature extraction algorithm.

The access control list may take any form. It could, for instance, be a list of one or more people's names, email addresses, or telephone numbers, or one or more device addresses, such as IP or MAC addresses. Although the ACL is referred to herein as a “list”, this should not be understood as restricting the data to any particular form, structure or encoding. The entities may be human users, organisations, machines, or any other identifiable entity.

The encryption apparatus preferably sends the access control list (ACL) to the key server over a secure channel (e.g., using TLS or SSL). It may encrypt the ACL separately, before sending it to the key server. The ACL may be encoded and communicated in any appropriate way.

The key server is preferably remote from the encryption apparatus and/or from the decryption apparatus—e.g., located in a different machine, building, city or country. Similarly, the feature server is preferably remote from the encryption apparatus and/or from the decryption apparatus. The key server and feature server may be provided by a common server or machine, but are preferably remote from each other.

A data network preferably connects any two or more of the encryption apparatus, the decryption apparatus, the key server and the feature server. The data network may comprise the Internet. The data network may additionally or alternatively comprise one or more other networks, such as a corporate LAN, a mobile telecommunications network, etc.

The key server may be configured to generate the cryptographic encryption key—preferably, in response to receiving the ACL. The key server may also generate a corresponding cryptographic decryption key. The decryption key may be generated at the same time as the encryption key—e.g., in response to receiving the ACL—or it may be generated later. The decryption key may be the same as the encryption key (e.g., for use in a symmetric encryption algorithm, such as AES), or they may differ (e.g., forming a key pair for use in an asymmetric encryption algorithm, such as RSA). In some embodiments, an encryption algorithm used by the encryption apparatus may enable a different respective decryption key to be sent to each entity on the ACL, in which case the key server may generate a set of decryption keys—e.g., in response to receiving the ACL.

The key server may be configured to store the cryptographic decryption key corresponding to the cryptographic encryption key in the data store, preferably in mutual association with the data identifier and/or the access control list. It may then retrieve the decryption key in response to receiving the associated data identifier as an incoming data identifier from an electronic decryption apparatus.

Alternatively, the key server may generate cryptographic decryption key associated with a data identifier in response to receiving the data identifier as an incoming data identifier from an electronic decryption apparatus. It may generate the decryption key using a key generation algorithm that takes the data identifier as input. The key generation algorithm may also take a master key as input; the master key may be stored in the key server.

The cryptographic encryption key is preferably sent to the encryption apparatus over a secure channel.

In some embodiments, the data identifier for the data is sent from the encryption apparatus to the key server, while in other embodiments it is sent from the key server to the encryption apparatus. The apparatus that sends the data identifier is preferably configured to generate the data identifier before sending it.

The data identifier may take any form—e.g. a random string of letters, or a serial number. The encryption apparatus or key server preferably generates a different data identifier each time it generates one. Each data identifier is preferably unique across the whole system, which may comprise a plurality of encryption apparatuses and/or decryption apparatuses. In some embodiments, the system may comprise a plurality of key servers, each configured to generate data identifiers; however, each data identifier is still preferably unique across the system.

The feature extraction algorithm is lossy in the sense that the input to the algorithm cannot be determined from the output of the algorithm. In this way, the algorithm removes information from the plaintext data. The feature set is preferably simply the output of the feature extraction algorithm. It may take any form. It may be an ordered data set, such as a sequence or string of symbols, or it may be an unordered set containing two or more members.

The feature extraction algorithm may divide the plaintext data into two or more elements. The feature set could simply be, or comprise, the unordered set of these elements, optionally with duplicates removed. In this way, information is lost concerning the position (and optionally the quantity) of each element in the plaintext data. Alternatively, the feature extraction algorithm may calculate a derived value for each element, using a derivation algorithm such as a hash algorithm. The derived value preferably contains less information than the element. The derivation algorithm is preferably not reversible. The derivation algorithm could be a known cryptographic hash algorithm, outputting a hash value for each element, or it could be an algorithm that is more computationally complex to reverse than it is to apply, or it could simply reduce the size of each element in any appropriate way, such as by a decimation process. The feature set could then comprise the set of derived values, optionally with duplicates removed.

The feature set may be encoded or represented in any appropriate way. The encryption apparatus may encrypt the feature set using any appropriate encryption algorithm. The encryption may be part of a communication protocol used for sending the feature set to the feature server—e.g., sending the feature set over a TLS or SSL encrypted channel—or it may be applied separately. By encrypting the feature set during communication, the data is protected from discovery by an unauthorised third party. The encrypted feature set may be encoded and sent in any appropriate way.

The encryption apparatus may be configured to send the data identifier to the feature server, preferably over a secure channel. The data identifier does not necessarily have to be represented identically each time it is used—for example, the identifier may be encoded differently at different times, or it may be a completely different identifier, but be associated with first data identifier. A mapping or association may be stored (e.g., in the key server, or elsewhere) between the different representations, if appropriate.

More generally, it will be appreciated that any data referred to herein may be encoded for storage and/or sending in any appropriate way.

The encryption apparatus preferably encrypts the plaintext data by using the received cryptographic encryption key in a standard encryption algorithm, such as AES.

The encryption apparatus is preferably configured to delete the encryption key from its memory after encrypting the plaintext data—e.g., within a predetermined time limit after the encryption. This can prevent an unauthorised party from reusing the same key.

The encryption apparatus preferably receives the plaintext data into a secure environment, and performs one or more, or all, of the steps of the feature extraction, the encryption of the feature set, and the encryption of the plaintext data, within the secure environment. The secure environment may be implemented using software and/or hardware on the apparatus. It may use a cryptographic coprocessor or other trusted hardware module. A single software application may control some or all of these steps. In this way, the plaintext data can be protected from inadvertent or malicious compromise.

The electronic decryption apparatus preferably comprises an interface for receiving the encrypted data over a communication channel or network—e.g., as an attachment to, or embedded in, an email message. The decryption apparatus may receive the data identifier with the encrypted data, or separately.

The decryption apparatus preferably sends the data identifier to the key server over a secure channel. The data identifier may be encoded and communicated in any appropriate way.

The decryption apparatus may identify the entity to the key server in any other way. In some embodiments, identifying the entity comprises authenticating the entity to the key server—e.g., using a cryptographic protocol. The entity may be the decryption apparatus itself, or it may be a user of the decryption apparatus. The entity may be a machine, a human user, or an organisation. Identifying the entity may comprise sending a password or biometric data received by the decryption apparatus from a user, or data derived from such a password or biometric data. Identifying the entity may comprise the decryption apparatus authenticating itself to the key server, and identifying a user of the decryption apparatus to the key server.

The cryptographic decryption key is preferably received by the decryption apparatus over a secure channel.

The decryption apparatus may store the plaintext data in a volatile or non-volatile memory of the apparatus. It may further be configured to output some or all of the plaintext data, which may be directly to a user of the apparatus (e.g., by displaying it on a display screen of the apparatus), or outputting it over a wired or wireless data connection to the apparatus.

The decryption apparatus is preferably configured to delete the decryption key from its memory after decrypting the plaintext data—e.g., within a predetermined time limit after the decryption. This can prevent an unauthorised party from accessing the key.

The encryption apparatus, decryption apparatus and/or key server may comprise any of the features disclosed in the applicant's earlier patent application WO 2011/083343, the entire contents of which are hereby incorporated by reference.

The key server preferably generates the cryptographic encryption key and the cryptographic decryption key. The keys may be generated at random, or they may, at least in part, be derived from data known to the key server, such as the ACL or the data identifier. The key server may generate the keys in response to receiving an access control list from the electronic encryption apparatus. However, it's also possible the encryption key and/or decryption key may have been generated before the access control list is received—i.e., ahead of time. The key server is, however, preferably configured to send a unique encryption key for each access control list it receives, or for each data identifier it sends or receives. As already noted, the cryptographic encryption key may be the same as the cryptographic decryption key, in which case only a single generation step is required.

The key server preferably comprises the data store, although it could be remote from the key server. The data store may be a structured database. The data identifier and access control list (and optionally an associated cryptographic decryption key) may be stored in any form or representation in the data store. They may be associated with each other in any appropriate way, physically or logically. They may, for example, be stored in a common record within a database comprising a plurality of records. The data store preferably stores a plurality of data identifiers and access control lists (and optionally cryptographic decryption keys), each of the plurality being in respective mutual association. The data identifiers may have been exchanged with the same one encryption apparatus, or with a plurality of similar encryption apparatuses.

The key server is preferably configured, when identifying the entity, to authenticate one or both of the electronic decryption apparatus and the entity. The key server is preferably configured not to send the cryptographic decryption key if the identified entity is not on the access control list.

The feature server preferably decrypts the received feature set (which may be part of the communication protocol), although, in some embodiments, the feature server may be configured to extract or process information in the received feature set without fully decrypting the feature set (e.g., if the feature server supports the use of a private information retrieval (PIR) protocol).

In addition to the received data, references to “feature set” in the following encompass information derived or extracted from the received feature set. The feature server preferably stores the feature set, or information derived from the feature set, in a volatile or non-volatile memory. The feature server preferably processes the decrypted or encrypted feature set. This processing may comprise applying an analysis algorithm to the feature set. The analysis algorithm may take just one feature set as input, or it may be able to take a plurality (e.g., tens, hundreds, thousands or millions) of feature sets as input. The analysis algorithm may perform statistical analysis of the feature set (or feature sets). The feature server may store or output a result of the analysis algorithm. It may store a result of the analysis algorithm in a data store (e.g., a database), preferably in association with the data identifier (in any appropriate form), which it preferably receives from the encryption apparatus. The feature server may use an output of the analysis algorithm to determine response data to send to the encryption apparatus or to the decryption apparatus.

In some embodiments, the encryption apparatus may send additional data to the feature server—e.g., meta data relating to the plaintext, or to the encryption apparatus or the user of the encryption apparatus. The feature server may use this additional data as input to the analysis algorithm.

The feature server may be configured to send response data to the encryption apparatus. The response data may depend on the feature set. The response data may instruct, or cause, the encryption apparatus to perform an action, which may comprise changing the plaintext data (e.g., adding advertising to the plaintext data) and/or outputting a message to the user of the encryption apparatus (e.g., an advertisement, warning, or information message).

The analysis algorithm may determine, from the feature set, if the plaintext meets a prompt condition, and may instruct the encryption apparatus to prompt the user if the prompt condition is met. The prompt condition may relate to whether the plaintext is likely to contain sensitive data, or malicious data, or banned data, or spam, or a keyword or phrase. The prompt may be a warning message, or an advertisement, etc.

The decryption apparatus may be configured to send the data identifier (in any appropriate form) to the feature server. It may do this before it sends the data identifier to the key server. The feature server may determine information to send to the decryption apparatus based on the received data identifier. It may retrieve an analysis result, associated with the data identifier, from a data store. Based on the data identifier or retrieved analysis result, the feature server may be configured to instruct the decryption apparatus to perform an action, which may comprise changing the data after it is decrypted (e.g., inserting advertising) and/or outputting a message to the user of the decryption apparatus (e.g., an advertisement, or a warning or information message).

Although, in most embodiments, it is expected that the feature server will be arranged to decrypt the received feature set, and to process the decrypted feature set, in some embodiments, the feature server may be arranged to process the encrypted feature set without decrypting the feature set fully or even at all. For instance, some known public-key encryption schemes have the property that they can process a ciphertext to change the underlying plaintext without decrypting the ciphertext. The feature set may be encrypted by the encryption apparatus using such a scheme, or any future cryptographic scheme that can do this, and the feature server may be arranged to change the encrypted feature set without decrypting the feature set. The feature server may send the changed feature set to the encryption apparatus, which may be arranged to decrypt this changed feature set to get useful feedback based on the feature set. The feature server need not have access to the decryption key for the feature set. An advantage of such a system is that the feature server learns nothing about the feature set since it does not know how to decrypt the incoming encrypted feature sets, thereby further preserving user privacy.

For instance, the encryption apparatus may be configured to encrypt the feature set, and to send the encrypted feature set to the feature server, according to a private information retrieval (PIR) protocol. The feature server may be configured to use the same private information retrieval (PIR) protocol to send response data to the encryption apparatus. The response data typically depends on the contents of the feature set; however, the use of private information retrieval (PIR) protocol makes it possible that the feature server cannot determine the contents of the feature set and/or cannot know what response data was sent. In this way, the privacy of a user of the encryption apparatus can be enhanced even further, by preventing the feature server from finding out anything about the contents of the plaintext data. As an example, the encryption apparatus may determine that one of a predefined list of keywords (e.g., medical or health-related terms) is present in the plaintext data (e.g., the term “blood pressure”), and can use a PIR protocol to query a database of response data on the feature server (e.g., adverts for medical or health products) based on the keyword, without the feature server being able to determine any information about the identity of the keyword. In this way, a user can be sent an advert for blood-pressure medication, without the operator of the feature server knowing what health keyword was detected in the plaintext data.

The applicant has realised that some of the same feature-extraction principles described above can be implemented in an electronic decryption apparatus as it decrypts data. Thus, from a further aspect, the invention provides an electronic decryption apparatus configured to:
receive an instruction to decrypt encrypted data;
decrypt the encrypted data, using a cryptographic decryption key, to recover plaintext data;
apply a lossy feature extraction algorithm to the plaintext data, to extract a feature set;
encrypt the feature set to generate an encrypted feature set;
send the encrypted feature set to a feature server; and
store the plaintext data.

From a further aspect, the invention provides a data decryption method, comprising an electronic decryption apparatus:
receiving an instruction to decrypt encrypted data;
decrypting the encrypted data, using a cryptographic decryption key, to recover plaintext data;
applying a lossy feature extraction algorithm to the plaintext data, to extract a feature set;
encrypting the feature set to generate an encrypted feature set;
sending the encrypted feature set to a feature server; and
storing the plaintext data.

The encrypted data may have a data identifier, and the electronic decryption apparatus may be configured to:
send the data identifier to a key server; and
receive, from the key server, said cryptographic decryption key, being a cryptographic decryption key associated with the data identifier.

The electronic decryption apparatus may be configured to identify an entity to the key server.

Any appropriate feature or features of earlier aspects or embodiments (including embodiments of the electronic encryption apparatus) described herein may be a feature or features of embodiments of this aspect also.

The key server may be a key server as described previously. The feature server may be a feature server as described previously. The key server or feature server may interact with the electronic decryption apparatus in some or all of the same ways as have already been described above with reference to electronic encryption apparatus. Where appropriate, features disclosed with reference to “encryption apparatus” herein should therefore also be seen as disclosing corresponding features with reference to the present decryption apparatus.

The decryption apparatus may receive the encrypted data over an interface. It may receive the encrypted data into a secure environment, and it may perform some or all of the steps of decryption, feature extraction, and encryption of the feature set, within the secure environment. The secure environment may be implemented using software and/or hardware on the apparatus. It may use a cryptographic coprocessor or other trusted hardware module. A single software application may control some or all of these steps. In this way, the plaintext data can be protected from inadvertent or malicious compromise.

Features of the previously-described decryption apparatus may be features of embodiments of this aspect also.

The encrypted data may be the encrypted data encrypted by an electronic encryption apparatus described herein.

The encryption apparatus, decryption apparatus, key server, and feature server, may each comprise any conventional components of electronic apparatus or devices, such as one or more of: a processor, a DSP, an ASIC, volatile memory, non-volatile memory, a display, a keyboard, a touch input mechanism, a battery, a network interface, a radio interface, a wired interface, etc. They may comprise software, stored in a memory of the apparatus or server, containing instructions for performing one or more of the operations described herein. Some operations described herein may alternatively be carried out by hardware—e.g., encryption or decryption may be performed on dedicated hardware such as cryptographic coprocessor or trusted platform module (TPM).

The key server may be a single server or may be distributed over a plurality of machines and/or physical locations. Similarly, the feature server may be a single server or may be distributed over a plurality of machines and/or physical locations.

Features of any aspect or embodiment described herein may, wherever appropriate, be applied to any other aspect or embodiment described herein. Where reference is made to different embodiments or sets of embodiments, it should be understood that these are not necessarily distinct but may overlap.

Certain preferred embodiments of the invention will now be described, by way of example only, with reference to the accompanying drawing, in which:

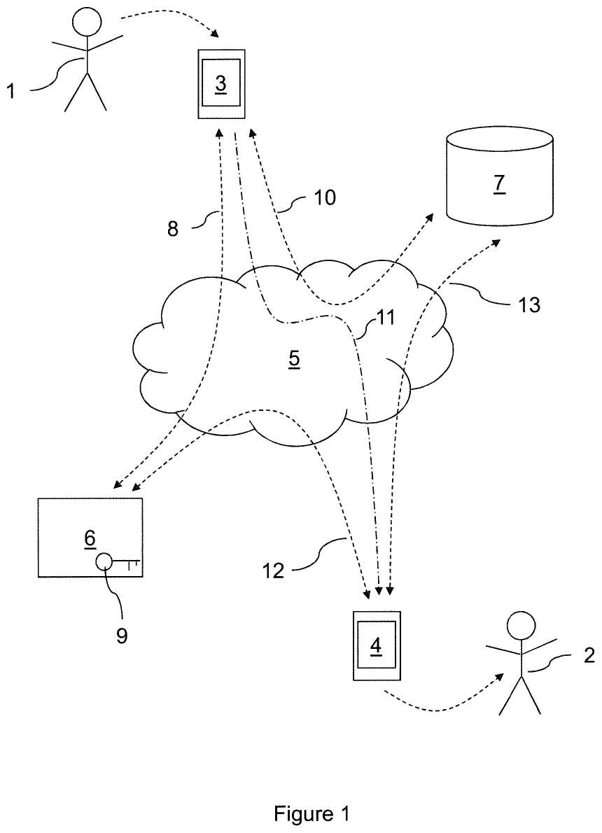

FIG. 1 is a schematic representation of a system embodying the invention.

FIG. 1 shows a first human user 1 and a second human user 2. The first user 1 uses a first communication device 3, while the second user 2 uses a second communication device 4. These devices 3, 4 are communicatively coupled via the Internet 5. They could be mobile telephones, laptop computers, personal computers, or any other electronic communication devices.

Also connected to the Internet 5 are a key server 6 and a feature server 7. Access to these servers 6, 7 may be restricted to authorised users.

In one particular usage example, the first user 1 is sending a confidential email to the second user 2. The first user 1 types the email into the first communication device 3 and identifies the intended recipient or recipients, thereby defining an access control list (ACL) of the names of those users who will be permitted to decrypt the email. In this example, the ACL just contains the second user 2.

The first communication device 3 then initiates a secure communication exchange 8 with the key server 6 (e.g., using SSL or TLS). The first communication device 3 sends the ACL to the key server 6, which responds by generating an identifier for the data (i.e., for the email, in this example), and a cryptographic key 9, which the key server 6 sends securely to the first communication device 3.

The key server 6 stores the ACL, the identifier for the data, and the cryptographic key in a database on the key server 6, for future use.

The first communication device 3 processes the email text by inputting it to a lossy feature extraction algorithm, which generates a feature set from the email. The feature set may contain information about the frequency of words, or letter strings, within the message, or about the appearance of certain words from a list of key words, or any other data set that contain a reduced level of information compared with the original message.

In this particular example, the first communication device 3 divides the email body into sequences of five symbols, then performs a hash function on each symbol sequence, removes any duplicate hashes, and randomly shuffles the resulting set of hashes, to generate a feature set from the shuffled hashes. In this way, it is not possible to reconstruct the original message, but the feature set nevertheless contains information about the email that can be used for various data analytics purposes, such as identifying spam or sending targeted advertising.

The first communication device 3 then initiates a secure communication exchange 10 with the feature server 7 (e.g., using SSL or TLS). The first communication device 3 sends the feature set to the feature server 7 over the secure link (i.e., with the feature set encrypted while it is in transit over the Internet 5). Along with the feature set, the first communication device 3 also sends contextual information including the identifier for the data, and optionally other meta data (e.g., the identity of the first user 1 and/or the identity of one or more intended recipients).

The feature server 7 may optionally send information to the first communication device 3, which the first communication device 3 might display to the first user 1 or process in any other appropriate way. The information may be determined based on the feature set, and/or on the identity of the first communication device 3 or of the first user 1. For example, the feature server 7 might use the feature set to send tailored advertisement information to be displayed to the first user 1 or to be appended to the email message; or the feature server 7 might process the feature set to check that it is not indicative of a probable breach of policy, such as leaking confidential corporate information, or violating a law in the jurisdiction of the recipient or recipients, or containing content such as spam or a virus.

Although this particular lossy feature extraction acts on text, it will be appreciated that existing or novel algorithms may be used to extract information from other types of message data, such as from audio data or visual data. For example, a photograph could be analysed to identify known structures or patterns in the image—e.g., a face-recognition algorithm could be used to identify people in a photograph, whose names could form the feature set.

The feature server 7 may make the feature set, or the results of analysis of the feature set (and optionally other meta data), available to authorised parties, such as a corporate IT department, or an advertising company, or a data analytics company, or a cyber-security company, or a government security agency. In some embodiments, the feature server 7 may process large numbers of feature sets—e.g., using machine learning or big data analytics techniques—to identify patterns or trends in the data.

In some embodiments, the first communication device 3 may communicate with the feature server 7 before performing the feature extraction algorithm, and may receive information from the feature server 7 relating to how the feature extraction should be performed, such as parameters for the lossy extraction algorithm.

The first communication device 3 then encrypts the email, using the cryptographic key 9 sent by the key server 6.

The feature extraction operation and the encryption operation preferably take place within a secure environment on the first communication device 3, so that the plaintext email is protected from malicious access by unauthorised users or software. The secure environment is created by software and/or hardware on the first communication device 3.

The encrypted email and the identifier for the data are stored in a memory of the first communication device 3—e.g., in an outbox of an email client running on the first communication device 3—before being sent by email along a path 11 to the second communication device 4. The path 11 can be a conventional email path—e.g. via one or more email servers, such as an SMTP server on an ISP or mobile telecoms network for the communications device 3. The identifier for the data may be included as a header for the email, or in the body of the email, or it could be sent in a separate email or through a different channel.

Alternatively, the encrypted data could be uploaded to a cloud storage facility, to be retrieved by the second user 2 (or any other user on the ACL, perhaps including user 1) at a later time.

Assuming the encrypted email is sent by email (e.g., as an email attachment), the second communication device 4 receives the email and extracts the identifier for the data. The second communication device 4 initiates a secure communication exchange 12 with the key server 6 (e.g., using SSL or TLS). The second communication device 4 authenticates the second user 2 to the key server 6. This may be done in any appropriate way—e.g., by means of a password, entered by the second user 2, that has previously been stored on the key server 6, or using a cryptographic key belonging to the second communication device 4 or to the second user 2, or using a fingerprint reader on the second communication device 4, etc.

The key server 6 uses the identifier for the data to identify the ACL in its database, and to check that the second user 2 is authorised to access the data, according to the ACL. Because, in this example, the second user 2 is on the ACL, the key server 6 sends the cryptographic key 9 to the second communication device 4.

The second communication device 4 may optionally also initiate a secure communication exchange 13 with the feature server 7 (e.g., using SSL or TLS), in order to retrieve any information relevant to the encrypted email. The second communication device 4 could display such information to the second user 2, and might give the user 2 the option of interrupting the decryption process. For example, the feature server 7 might send advertisement information, or it might send a legal disclaimer or corporate signature relating to the email, or it might send the results of a spam check or malware scan performed by the feature server 7 on the feature set.

The second communication device 4 then uses the cryptographic key 9 to decrypt the email message, and displays the decrypted text on a display screen of the second communication device 4, for the second user 2 to read.

While the above example refers to a single cryptographic key 9, it will be appreciated that, in other embodiments, the key server 6 may store a key pair consisting of an encryption key and a corresponding, different decryption key, or may store more larger groups of interrelated keys. The key server 6 would then send an appropriate encryption key to the first communication device 3, and a corresponding decryption key to the second communication device 4.

In summary, the key server 6 is responsible for: managing identifiers for data; verifying the identity of users; processing access control lists (ACLs); and distributing cryptographic keys. The feature server 7 is responsible for providing intelligence to users based on information extracted from feature vectors, and optionally from additional contextual information sent to the feature server 7. The feature server 7 extracts this information using machine intelligence methods, including machine learning and big data analytics.

Note that neither the key server 6 nor the feature server 7 has access to the plaintext or the ciphertext. This ensures that the feature set, and any optional meta data, is the only information about the content of the message that is made available to entities other than the sender (e.g., the first user 1) and those on the ACL (e.g., the second user 2).

Other communication mechanisms than email are, of course, also possible, such as social-media network uploads, SMS message, Skype™ call, WhatsApp™ message, etc. For example, the message could be a social-media message, with the role of the second communication device 4 above being taken instead by a server of a social-media platform provider, such as FaceBook™. The feature server might send tailored advertisement information to the first user as a banner or other content within a web page of the associated social-media portal.

In another set of embodiments, the first communication device 3 might not communicate with the feature server 7 at all, but instead the feature set may be generated by the second communication device 4 after it decrypts a received encrypted message, and sent by the second communication device 4 to the feature server 7 for analysis. Such a decryption operation and feature extraction operation preferably take place within a secure environment on the second communication device 4, so that the plaintext message is protected from malicious access by unauthorised users or software. The secure environment is created by software and/or hardware on the second communication device 4. Again, in some such embodiments it is possible that the message could be a social-media message, with the role of the first communication device 3 being taken by a server of a social-media platform provider, such as FaceBook™. The feature server 7 might send tailored advertisement information to the second user, or might send a warning if it detects malicious or inappropriate content through analysis of the feature vector—e.g., if it detects obscene content in an encrypted social-media post or message.

This architecture enables the application of machine-learning by extracting features from data before it is encrypted, or once it is decrypted. This enables a controlled amount of information to be extracted from messages for other purposes, such as security or advertising. Different choices of lossy algorithm can represent a trade-off between the level of privacy for the users and the accuracy and range of information that can be extracted.

It will be appreciated by those skilled in the art that the invention has been illustrated by describing one or more specific embodiments thereof, but is not limited to these embodiments; many variations and modifications are possible, within the scope of the accompanying claims.

1-4. (canceled)

5. A system comprising an electronic encryption apparatus configured to:
receive an instruction to encrypt plaintext data;
receive an access control list that identifies one or more entities that are to be permitted to decrypt the data;
send the access control list to a key server;
receive, from the key server, a cryptographic encryption key;
exchange, with the key server, a data identifier for the data;
apply a lossy feature extraction algorithm to the plaintext data, to extract a feature set;
encrypt the feature set to generate an encrypted feature set;
send the encrypted feature set to a feature server;
encrypt the plaintext data, using the received cryptographic encryption key, to generate encrypted data; and
store the encrypted data and the data identifier.

6. The system of claim 5, wherein the electronic encryption apparatus, is further configured to receive the plaintext data into a secure environment, and to perform one or more of (i) said lossy feature extraction, (ii) encrypting the feature set, and (iii) encrypting the plaintext data, within the secure environment.

7. The system of claim 5, wherein the electronic encryption apparatus, is further configured to use one or more encrypted channels when (i) sending the access control list to the key server, (ii) receiving the cryptographic encryption key from the key server, and (iii) exchanging the data identifier with the key server.

8. A key server configured:
to receive an access control list from an electronic encryption apparatus;
to send a cryptographic encryption key to the electronic encryption apparatus;
to exchange a data identifier with the electronic encryption apparatus;
to store the data identifier and the access control list, in mutual association in a data store;
to receive, from an electronic decryption apparatus, an incoming data identifier;
to receive, from the electronic decryption apparatus, an identification of an entity;
to identify, in the data store, an access control list associated with the incoming data identifier;
to check whether the entity is on the access control list associated with the incoming data identifier; and
if the entity is on the access control list associated with the incoming data identifier, to retrieve or generate a cryptographic decryption key associated with the incoming data identifier, and to send the cryptographic decryption key associated with the incoming data identifier to the electronic decryption apparatus.

9. The key server of claim 8, configured to generate said cryptographic encryption key in response to receiving the access control list.

10. A method comprising an electronic encryption apparatus:
receiving an instruction to encrypt plaintext data;
receiving an access control list that identifies one or more entities that are to be permitted to decrypt the data;
sending the access control list to a key server;
receiving, from the key server, a cryptographic encryption key;
exchanging, with the key server, a data identifier for the data;
applying a lossy feature extraction algorithm to the plaintext data, to extract a feature set;
encrypting the feature set to generate an encrypted feature set;
sending the encrypted feature set to a feature server;
using the received cryptographic encryption key to encrypt the plaintext data, to generate encrypted data; and
storing the encrypted data and the data identifier.

11. The method of claim 10, further comprising the key server:
receiving the access control list from the electronic encryption apparatus;
sending the cryptographic encryption key to the electronic encryption apparatus;
exchanging said data identifier with the electronic encryption apparatus; and
storing the data identifier and the access control list, in mutual association in a data store.

12-14. (canceled)

15. The system of claim 5, wherein the electronic encryption apparatus is further configured to transmit the encrypted data over a communication channel or network.

16. The system of claim 5, wherein the electronic encryption apparatus is further configured to send the encrypted data and the data identifier to one or more of the entities identified in the access control list.

17. The system of claim 5, wherein the electronic encryption apparatus is a cell phone.

18. The system of claim 5, wherein the feature set comprises an unordered set of elements extracted from the plaintext data.

19. The system of claim 5, wherein the electronic encryption apparatus is further configured to receive response data from the feature server, and to change the plaintext data, or to output a message to a user, in dependence on the received response data.

20. The system of claim 5, further comprising the key server, wherein the key server is configured:
to receive the access control list from the electronic encryption apparatus;
to send the cryptographic encryption key to the electronic encryption apparatus;
to exchange the data identifier with the electronic encryption apparatus; and
to store the data identifier and the access control list, in mutual association in a data store.

21. The system of claim 5, further comprising an electronic decryption apparatus, wherein the electronic decryption apparatus is configured to:
receive an instruction to decrypt the encrypted data;
send the data identifier to the key server;
identify an entity to the key server;
receive, from the key server, a cryptographic decryption key associated with the data identifier;
decrypt the encrypted data, using the cryptographic decryption key, to recover the plaintext data; and
store the plaintext data.

22. The system of claim 21, wherein the key server is further configured:
to receive the data identifier from the electronic decryption apparatus;
to receive the identification of an entity from the electronic decryption apparatus;
to identify, in the data store, the access control list associated with the data identifier;
to check that the entity is on the access control list associated with the data identifier; and
in response to determining that the entity is on the access control list associated with the data identifier, to retrieve or generate the cryptographic decryption key associated with the data identifier, and to send the cryptographic decryption key associated with the data identifier to the electronic decryption apparatus.

23. The system of claim 5, further comprising the feature server, wherein the feature server is configured to receive the encrypted feature set from the electronic encryption apparatus and to store the encrypted feature set in a memory of the feature server.

24. The system of claim 23, wherein the feature server is further configured to extract or process information in the encrypted feature set without fully decrypting the feature set.

25. The system of claim 23, wherein the feature server is configured to process the encrypted feature set using a private information retrieval (PIR) protocol and to send response data to the electronic encryption apparatus, without the feature server determining the contents of the encrypted feature set, wherein the response data depends on the contents of the encrypted feature set.

26. The method of claim 11, further comprising an electronic decryption apparatus:
receiving an instruction to decrypt the encrypted data;
sending the data identifier to the key server;
identifying an entity to the key server;
receiving, from the key server, a cryptographic decryption key associated with the data identifier; and
decrypting the encrypted data, using the cryptographic decryption key, to recover the plaintext data.

27. The method of claim 26, further comprising the key server:
receiving the data identifier from the electronic decryption apparatus;
receiving the identification of an entity from the electronic decryption apparatus;
identifying, in the data store, the access control list associated with the data identifier;
checking that the entity is on the access control list associated with the data identifier; and
in response to determining that the entity is on the access control list associated with the data identifier, retrieving or generating the cryptographic decryption key associated with the data identifier, and sending the cryptographic decryption key associated with the data identifier to the electronic decryption apparatus.
